(19) United States
(12) Patent Application Publication
(10) Pub. No.: US 2025/0128102 A1
(43) Pub. Date: Apr. 24, 2025

(54) FIRE PREVENTION SYSTEM USING VIRTUAL REALITY

(71) Applicant: ROZETATECH Co., Ltd., Seongnam-si (KR)

(72) Inventors: Young-Jin CHO, Seongnam-si (KR); Chang-Sik JUNG, Seoul (KR)

(21) Appl. No.: 18/825,097

(22) Filed: Sep. 5, 2024

(30) Foreign Application Priority Data
Oct. 19, 2023 (KR) 10-2023-0140515

(51) Int. Cl. A62C 99/00; G06F 3/01; G08B 7/06

(52) U.S. Cl. CPC A62C 99/0081; G06F 3/011; G08B 7/066

(57) ABSTRACT

Provided is a fire prevention system including a plurality first sensors, a plurality of second sensors, a server system configured to generate virtual reality, an image providing unit configured to provide the virtual reality to a user, wherein the server system includes a data processing unit, a virtual space modeling unit, a content generating unit configured to generate an educational drill scenario, and a simulation unit configured to output the educational drill scenario into the virtual space to generate the virtual reality, wherein the image providing unit may provide different virtual reality depending on the user.

### CROSS-REFERENCE TO RELATED APPLICATIONS

This U.S. non-provisional patent application claims priority under 35 U.S.C. § 119 of Korean Patent Application No. 10-2023-0140515, filed on Oct. 19, 2023, the entire contents of which are hereby incorporated by reference.

### BACKGROUND

The present disclosure herein relates to a fire prevention system using virtual reality.

In modern society, a variety of items, such as various electronic products, firearms, products containing flammable substances, and products containing explosive substances, are being used, and as a result, there is risk that a fire may break out at any time in buildings such as houses and shopping malls, mountains, and the like.

As such, fires are disasters that may occur anytime and anywhere, but once fires occur, the fires often cause great economic damage and casualties, so that it is a very important task to quickly respond to the occurrence of fires.

However, in the event of an actual fire, there is a risk of being exposed to the fire due to inability to quickly respond to the fire, which is the result of lack of knowledge of how to use firefighting facilities and insufficient fire evacuation drills.

### SUMMARY

The present disclosure provides a fire prevention system capable of providing protection education against fires and evacuation drills through virtual reality.

An embodiment of the inventive concept provides a fire prevention system using virtual reality, wherein the system includes a plurality of first sensors, each of which is configured to detect an outbreak of fire, generate virtual fire information and address information, and perform radio frequency (RF) communication with each other, a plurality of second sensors respectively attached to a plurality of facilities placed in a building and configured to acquire facility information of each of the plurality of facilities, a server system configured to generate the virtual reality, and an image providing unit configured to communicate with the server system, and provide the virtual reality to a user, wherein the server system includes a data processing unit configured to receive the virtual fire information, the address information, the facility information, and information on the user, and generate position information of the plurality of first sensors and state information of the plurality of facilities, a virtual space modeling unit configured to virtually implement the building and the plurality of facilities to generate a virtual space, a content generating unit configured to generate an educational drill scenario based on the address information, the facility information, and the information on the user, and a simulation unit configured to output the educational drill scenario, the position information, and the state information into the virtual space to generate the virtual reality, wherein the image providing unit is configured to provide different virtual reality depending on the user.

In an embodiment, the user may include a firefighter and an operator.

In an embodiment, if the user is the firefighter, the educational drill scenario may include a firefighting drill scenario, and the image providing unit may provide the firefighter with the firefighting drill scenario through the virtual reality.

In an embodiment, if the user is the operator, the educational drill scenario may include a fire evacuation drill scenario, and the image providing unit may be configured to provide the operator with the fire evacuation drill scenario through the virtual reality.

In an embodiment, the server system may further include an evacuation route calculating unit configured to generate an evacuation route algorithm, and the content generating unit may additionally use the evacuation route algorithm to generate the fire evacuation drill scenario.

In an embodiment, the evacuation route calculating unit may include a fire detection data collection unit configured to receive the virtual fire information from the data processing unit, a space data receiving unit configured to receive the virtual space from the virtual space modeling unit, an operation unit configured to calculate a plurality of routes by performing a parallel operation based on Compute Unified Device Architecture (CUDA), a shortest route calculating unit configured to calculate the shortest route among the plurality of routes based on the Dijkstra algorithm, and an algorithm generating unit configured to generate the evacuation route algorithm by visualizing the shortest route.

In an embodiment, the data processing unit may further generate a fire index for evaluating a risk of a fire based on an ignition factor, the facility information, the state information, and the position information.

In an embodiment, the fire index may be provided for each zone, facility, and fuel.

In an embodiment, the ignition factor may include an electrical factor, a mechanical factor, a gas leak, a chemical factor, and a natural factor.

In an embodiment, the content generating unit may additionally use the fire index to generate the educational drill scenario.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 illustrates a fire prevention system using virtual reality according to an embodiment of the inventive concept;

FIG. 2 is a block diagram of a server system according to an embodiment of the inventive concept;

FIG. 3 illustrates a user wearing an image providing unit according to an embodiment of the inventive concept;

FIG. 4 illustrates an evacuation route calculating unit according to an embodiment of the inventive concept;

FIG. 5 illustrates a portion of virtual reality provided by an image providing unit according to an embodiment of the inventive concept; and

FIG. 6 illustrates a portion of virtual reality provided by an image providing unit according to an embodiment of the inventive concept.

### DETAILED DESCRIPTION

In the present disclosure, when an element (or a region, a layer, a portion, and the like) is referred to as being “on,” “connected to,” or “coupled to” another element, it means that the element may be directly disposed on/connected to/coupled to the other element, or that a third element may be disposed therebetween.

Like reference numerals refer to like elements. Also, in the drawings, the thickness, the ratio, and the dimensions of elements are exaggerated for an effective description of technical contents. The term “and/or,” includes all combinations of one or more of which associated components may define.

It will be understood that, although the terms “first,” “second,” etc. may be used herein to describe various elements, these elements should not be limited by these terms. These terms are only used to distinguish one element from another. For example, a first element may be referred to as a second element, and a second element may also be referred to as a first element in a similar manner without departing the scope of rights of the present invention. The terms of a singular form may include plural forms unless the context clearly indicates otherwise.

In addition, terms such as “below,” “lower,” “above,” “upper,” and the like are used to describe the relationship of the components shown in the drawings. The terms are used as a relative concept and are described with reference to the direction indicated in the drawings.

It should be understood that the term “comprise,” or “have” is intended to specify the presence of stated features, integers, steps, operations, elements, components, or combinations thereof in the disclosure, but do not preclude the presence or addition of one or more other features, integers, steps, operations, elements, components, or combinations thereof.

Unless otherwise defined, all terms (including technical and scientific terms) used herein have the same meaning as commonly understood by one of ordinary skill in the art to which the present invention pertains. It is also to be understood that terms such as terms defined in commonly used dictionaries should be interpreted as having meanings consistent with the meanings in the context of the related art, and should not be interpreted in too ideal a sense or an overly formal sense unless explicitly defined herein.

Hereinafter, embodiments of the inventive concept will be described with reference to the accompanying drawings.

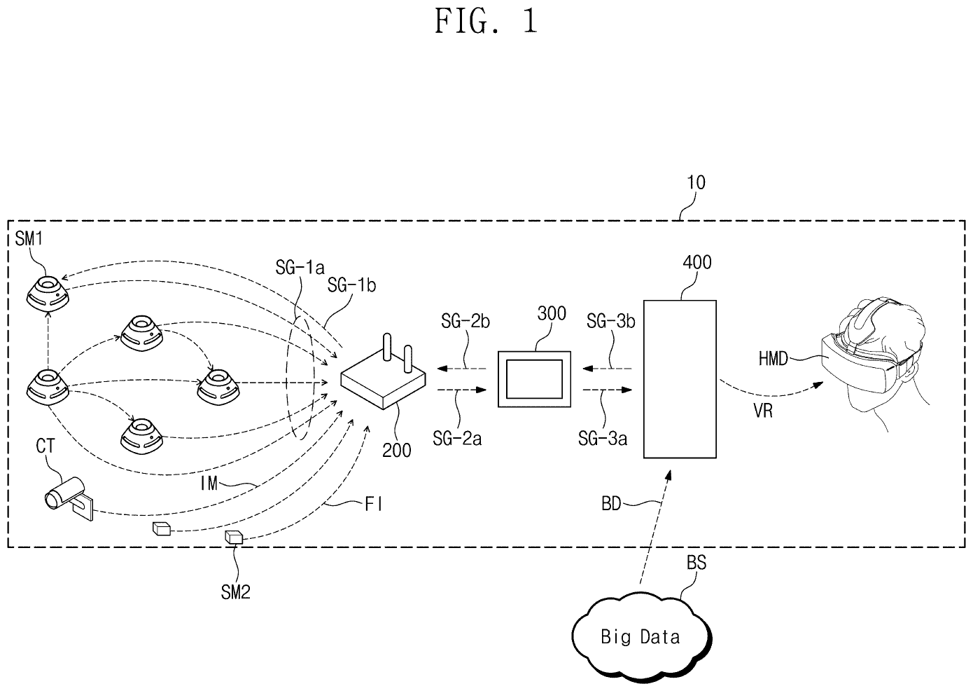

FIG. 1 illustrates a fire prevention system using virtual reality according to an embodiment of the inventive concept.

Referring to FIG. 1, a fire prevention system 10 may provide a user with response training using virtual reality to prevent fires.

The fire prevention system 10 may include a plurality of first sensors SM1, an image recording unit CT, a plurality of second sensors SM2, a repeater 200, a receiver 300, a server system 400, and an image providing unit HMD.

Each of the plurality of first sensors SM1 may detect whether a fire has occurred. In addition, even if there is no fire that has occurred, the plurality of first sensors SM1 may transmit information on a state (e.g., information on the current temperature, smoke, humidity, or gases in a place in which a sensor is installed). In FIG. 1, five first sensors SM1 are exemplarily illustrated, but the embodiment of the inventive concept is not limited thereto. Each of the plurality of first sensors SM1 may transmit a first fire information signal SG-1a including fire information to an adjacent first sensors SM1 and/or the repeater 200.

The plurality of first sensors SM1 may generate and transmit virtual fire information and address information. For the purpose of an educational drill, the virtual fire information may include that a virtual fire has occurred. The address information may include a unique identification number, a placement position, and the like of each of the plurality of first sensors SM1.

The first fire information signal SG-1a may be a signal generated by the first sensor SM1 which detected the occurrence of a fire or a signal amplified by the first sensor SM1.

As a method for transmitting the first fire information signal SG-1a, a radio frequency (RF) communication method may be used. The RF communication method may be a communication method for exchanging information by radiating a radio frequency. The RF communication method is a broadband communication method using a frequency, and may have high stability due to less influence of climate and environment. The RF communication method can link voice or other additional functions, and may have a fast transmission speed. For example, the RF communication method may use a frequency in a band of 447 MHz to 924 MHz. However, this is only exemplary, and in an embodiment of the inventive concept, a communication method such as Ethernet, Wi-Fi, LoRA, M2M, 3G, 4G, LTE, LTE-M, Bluetooth, Wi-Fi Direct, or the like may be used.

In an embodiment of the inventive concept, the RF communication method may include the Listen Before Transmission (LBT) communication method. The LBT communication method is a frequency selection method that determines whether a selected frequency is being used by another system, and when it is determined that the selected frequency is occupied, then selects again another frequency. For example, a node intended for transmission may first listen to a medium, determine if it is in an idle state, and then, flow a back-off protocol prior to the transmission. By subjecting data to distributed processing using the LBT communication method, collisions between signals in the same band may be prevented.

The image recording unit CT may capture an image IM. The image recording unit CT may transmit the captured image IM to the repeater 200.

The plurality of second sensors SM2 may be attached to a plurality of facilities placed in a building. The plurality of second sensors SM2 may acquire facility information FI of each of the plurality of facilities. The plurality of second sensors SM2 may transmit the facility information FI to the repeater 200. The facility information FI may include information on the state of a facility, such as the temperature, rotation speed, number of rotations, pressure, and inflow of a facility in which each of the plurality of second sensors SM2 is installed.

The repeater 200 may perform the RF communication with the plurality of first sensors SM1. For example, the repeater 200 may communicate with 40 first sensors SM1. The repeater 200 may receive the first fire information signal SG-1a from the plurality of first sensors SM1. The repeater 200 may convert the first fire information signal SG-1a into a second fire information signal SG-2a. The second fire information signal SG-2a may include the fire information. The repeater 200 may transmit the second fire information signal SG-2a to the receiver 300.

The RF communication method may be used as a method for transmitting the second fire information signal SG-2a. That is, the repeater 200 and receiver 300 may perform the RF communication.

The receiver 300 may receive the second fire information and signal SG-2a from the repeater 200. The receiver 300 may convert the second fire information signal SG-2a into a third fire information signal SG-3a. The third fire information signal SG-3a may include the fire information. The receiver 300 may transmit the third fire information signal SG-3a to the server system 400.

The RF communication method may be used as a method for transmitting the third fire information signal SG-3a. That is, the receiver 300 the server system 400 may perform the RF communication.

The server system 400 may determine the situation of a fire based on the third fire information signal SG-3a received from the receiver 300.

When the server system 400 receives the third fire information signal SG-3a, the server system 400 may transmit a third response signal SG-3b to the receiver 300.

When the receiver 300 receives the second fire information signal SG-2a or the third response signal SG-3b, the receiver 300 may transmit a second response signal SG-2b to the repeater 200.

When the repeater 200 receives the first fire information signal SG-1a or the second response signal SG-2b, the repeater 200 may transmit the first response signal SG-1b to the plurality of first sensors SM1.

The server system 400 may receive big data BD from an external second server BS. The big data BD may be periodically updated. The big data BD may refer to data in a volume beyond the ability of a typical software tool to collect, manage, and process within an acceptable cure time as a means of predicting a diversified society. Such mass data may provide more insight than typical limited data.

The big data BD may include information on buildings. For example, the big data BD may include information on large complex buildings, information on condominiums, information on commercial facilities, information on traditional markets, information on schools, information on town halls, information on military bases, information on national parks, information on hospitals. information, on apartment complexes, information on houses, and the like.

The big data BD may include surrounding environment data for determining whether a fire has occurred. For example, the surrounding environment data may include at least one of data corresponding to the probability of fire occurrence by date, data corresponding to the probability of fire occurrence by time, data corresponding to the probability of fire occurrence by space, data corresponding to the probability of fire occurrence by temperature, data corresponding to the probability of fire occurrence by humidity, data corresponding to the probability of fire occurrence by weather, data corresponding to the probability of fire occurrence by industry, and data corresponding to the probability of fire occurrence by user.

For example, the data corresponding to the probability of fire occurrence by date may include the probability of fire occurrence by day of the week and the probability of fire occurrence by month. The data corresponding to the probability of fire occurrence by time may include the probability of fire occurrence divided into early morning, morning, afternoon, evening, late night, or the like. The data corresponding to the probability of fire occurrence by space may include the probability of fire occurrence divided into city center, mountain regions, beaches, rural areas, or the like. The data corresponding to the probability of fire occurrence by temperature may include the probability of occurrence of fire divided into spring, summer, autumn, or winter. The data corresponding to the probability of fire occurrence by humidity may include the probability of fire occurrence by specific humidity level. The data corresponding to the probability of fire occurrence by weather may include the probability of fire occurrence divided into sunny days, cloudy days, rainy days, or the like. The data corresponding to the probability of fire occurrence by industry may include the probability of fire occurrence divided into homes, restaurants, factories, offices, or the like. The data corresponding to the probability of fire occurrence by user may include the probability of fire occurrence divided into age, occupation, gender, or the like.

The server system 400 may generate virtual reality VR.

The server system 400 may generate virtual reality according to an educational drill scenario, and may provide the generated virtual reality to a user. For example, the user may include a firefighter and an operator. The users may conduct fire evacuation drills, fire response drills, and firefighting drills in virtual reality through the image providing unit HMD. The above will be described later.

The image providing unit HMD may communicate with the server system 400. The image providing unit HMD may receive the virtual reality VR from the server system 400. The image providing unit HMD may provide the user with the virtual reality VR.

The image providing unit HMD is a virtual reality (VR) device and/or an augmented reality (AR) device, and may be a head mounted display, a desktop computer capable of communication, a laptop computer, a notebook, a smart phone, a tablet PC, a mobile phone, a smart watch, a smart glass, an e-book reader, a portable multimedia player (PMP), a portable game console, a GPS device, a digital camera, a digital multimedia broadcasting (DMB) player, a digital audio recorder, a digital audio player, a digital video recorder, a digital video player, a personal digital assistant (PDA), or the like.

The image providing unit HMD may provide different virtual reality VR depending on the user. The above will be described later.

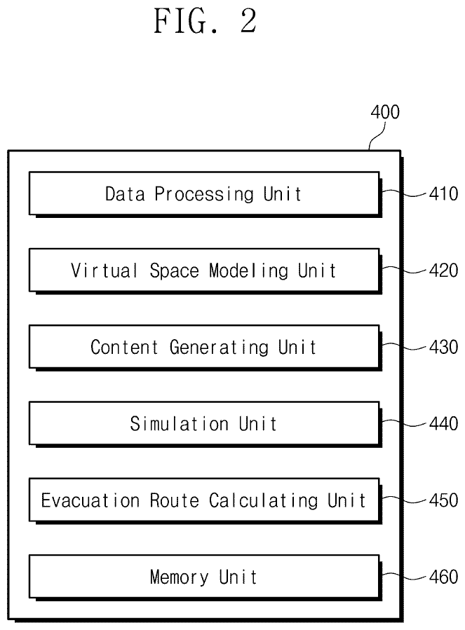

FIG. 2 is a block diagram of a server system according to an embodiment of the inventive concept.

Referring to FIG. 1 and FIG. 2, the server system 400 may include a data processing unit 410, a virtual space modeling unit 420, a content generating unit 430, a simulation unit 440, an evacuation route calculating unit 450, and a memory unit 460.

Each component of the server system 400 may be composed of individual servers connected to each other by an internal network. However, this is merely an example, and a method by which the server system 400 is configured is not limited thereto. For example, each component of the server system 400 may be included and provided in one server.

The data processing unit 410 may receive the virtual fire information and the address information generated by the plurality of first sensors SM1. The data processing unit 410 may receive the captured image IM from the image recording unit CT. The data processing unit 410 may receive the facility information FI generated by the plurality of second sensors SM2. The data processing unit 410 may receive information on a user from a terminal of the user.

The data processing unit 410 may generate position information of the plurality of first sensors SM1 based on the received address information and may generate state information of the plurality of second sensors SM2 based on the facility information.

The data processing unit 410 may further generate a fire index for evaluating a risk of a fire based on an ignition factor, the facility information, the state information, the position information.

The ignition factor may refer to a factor in combination of an ignition heat source and an initial complex, which causes the occurrence of a fire. The ignition factor may include an electrical factor, a mechanical factor, a gas leak, a chemical factor, and a natural factor.

For example, the electrical factor may include accumulation, ground fault, poor contact, insulation deterioration, overload, overcurrent, partial disconnection, interlayer short-circuit, pressing, damage, and the like.

The mechanical factor may include overheating, overload, oil or fuel leaks, control failure, poor maintenance, aging, backfire, damaged valves, and the like.

The chemical factor may include chemical explosions, contact between water-prohibiting substances with water, chemical ignition, natural ignition, mixed ignition, and the like.

The fire index may be provided for each zone, facility, and fuel. As a result, a fire index may be generated for each of major facilities, such as turbines, boilers, coal yards, and the like.

According to the inventive concept, it is possible to facilitate the prevention of fires in consideration of causes of the fires and targets of the fires. Therefore, it is possible to provide the fire prevention system 10 with improved reliability.

The virtual space modeling unit 420 may virtually implement a building and a plurality of facilities to generate a virtual space. The virtual space modeling unit 420 may reverse engineer the building and the plurality of facilities to generate 3D modeling.

The virtual space modeling unit 420 may receive point cloud data received through a laser scanning process.

The virtual space modeling unit 420 may additionally use the image IM received from the image recording unit CT.

The virtual space modeling unit 420 may process the reverse engineering data and the point cloud data to generate a virtual space. The virtual space may be implemented using Building Information Modeling (BIM) and/or Digital Twin.

The content generating unit 430 may generate an educational drill scenario based on the address information, the facility information, and the user information. The content generating unit 430 may further use the fire index generated by the data processing unit 410 to generate the educational drill scenario.

According to the inventive concept, the fire index may determine the cause of a fire, and may be used as basic data for fire prevention policies to improve the reliability of the above-described educational drill scenario. It is possible to provide the fire prevention system 10 capable of generating an optimized educational drill scenario.

The educational drill scenario may include a firefighting drill scenario and a fire evacuation drill scenario. The firefighting drill scenario and the fire evacuation drill scenario may be suitably provided depending on the user.

The simulation unit 440 may receive the virtual space generated by the virtual space modeling unit 420, the position information of the plurality of first sensors SM1 and the state information of the plurality of the second sensors SM2 from the data processing unit 410, and the educational drill scenario from the content generating unit 430.

The simulation unit 440 may output the educational drill scenario, the position information, and the state information into the virtual space to generate the virtual reality VR.

The virtual reality VR may be visualized and virtualized by synchronizing the virtual space, the educational drill scenario, the position information, and the state information.

The evacuation route calculating unit 450 may generate an evacuation route algorithm. The above will be described later.

The content generating unit 430 may further use the evacuation route algorithm to generate the fire evacuation drill scenario.

The memory unit 460 may store data required to operate the server system 400. For example, the memory unit 460 may store the educational drill scenario generated by the content generating unit 430.

The memory unit 460 may include a volatile memory or a non-volatile memory. The volatile memory may include a DRAM, an SRAM, a flash memory, or an FeRAM. The non-volatile memory may include an SSD or an HDD.

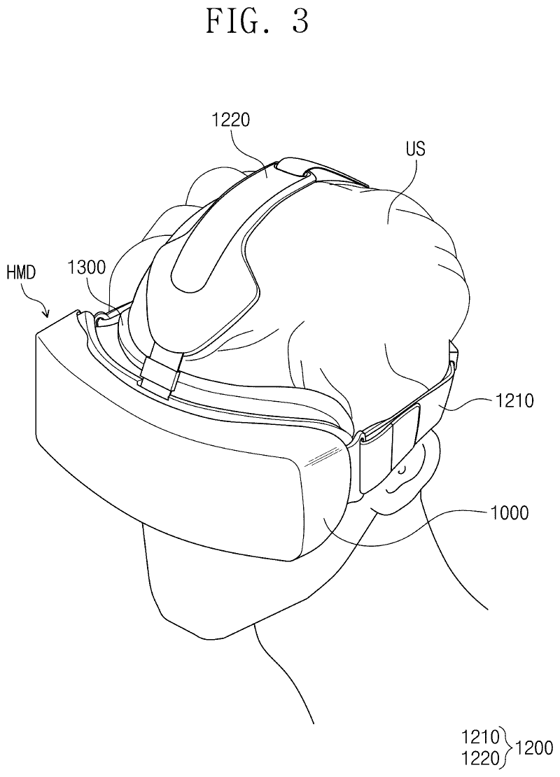

FIG. 3 illustrates a user wearing an image providing unit according to an embodiment of the inventive concept.

Referring to FIG. 3, the image providing unit HMD may be provided in various forms to a user. For example, the image providing unit HMD may configure a wearable device and provide an image to the user. For example, the image providing unit HMD may be in the form of a head-mounted display which the user may wear on his/her head, or a glasses-type display which the user may wear like glasses.

The image providing unit HMD may include a display device 1000, a wearing part 1200, and a cushion part 1300.

The display device 1000 may cover the eyes of a user US so as to correspond to the left eye and the right eye of the user US.

The wearing part 1200 may be coupled to the display device 1000 so as to allow the user to easily wear the display device 1000. FIG. 3 illustrates, as an example, the wearing part 1200 including a main strap 1210 worn surrounding the head circumference of the user US and an upper strap 1220 connecting the display device 1000 and the main strap 1210 along the top of the head.

The main strap 1210 may fix the display device 1000 to be pressed against the head of the user US. The upper strap 1220 may prevent the display device 1000 from slipping down, and may disperse the load of the display device 1000 to further improve the fit felt by the user US.

FIG. 3 illustrates, as an example, that the length of each of the main strap 1210 and the upper strap 1220 is adjustable, but the embodiment of the inventive concept is not limited thereto. For example, each of the main strap 1210 and the upper strap 1220 may not have a part that adjusts the length thereof, but may have a string having elasticity.

If it is possible to fix the display device 1000 to the user US, the wearing part 1200 may be transformed into various shapes in addition to the form illustrated in FIG. 3. For example, the upper strap 1220 may be omitted. In addition, in another embodiment of the inventive concept, the wearing part 1200 may also be transformed into various shapes, such as a helmet coupled to the display device 1000 or glasses legs coupled to the display device 1000.

When the image providing unit HMD is worn, the cushion part 1300 may be disposed to be pressed against the face of the user US. The cushion part 1300 may be freely deformed, and may absorb an impact applied to the image providing unit HMD. For example, the cushion part 1300 may be a polymer resin, a foam sponge, or the like, and may include polyurethane, polycarbonate, polypropylene, polyethylene, and the like. However, the material of the cushion part 1300 is not limited to the above-described examples. Meanwhile, the cushion part 1300 may be omitted.

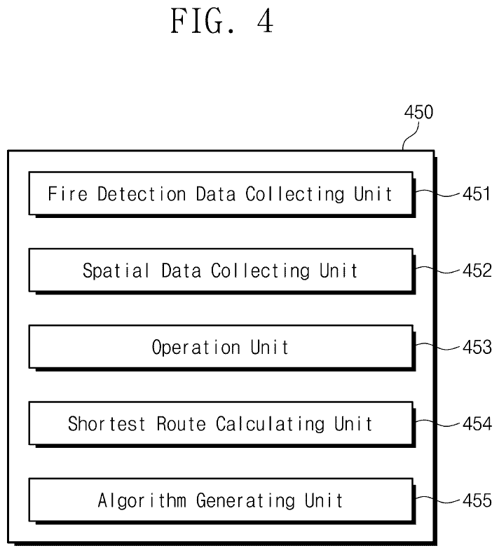

FIG. 4 illustrates an evacuation route calculating unit according to an embodiment of the inventive concept.

Referring to FIG. 2 and FIG. 4, the evacuation route calculating unit 450 may include a fire detection data collecting unit 451, a spatial data collecting unit 452, an operation unit 453, a shortest route calculating unit 454, and an algorithm generating unit 455.

The fire detection data collecting unit 451 may receive fire information or virtual fire information from the data processing unit 410. The fire detection data collecting unit 451 may further receive information on directional information displayed by the plurality of first sensors SM1.

The spatial data collecting unit 452 may receive the virtual space from the virtual space modeling unit 420. The spatial data collecting unit 452 may convert a building structure into a graph structure based on the virtual space. The graph structure may be formed based on a graph theory.

The operation unit 453 may calculate a plurality of routes by performing a parallel operation based on Compute Unified Device Architecture (CUDA). The plurality of routes may include various routes from the point of a fire as determined based on the virtual fire information to an emergency exit.

If the point of the fire is defined as a, and the emergency exit is defined as b, the operation unit 453 may calculate a plurality of routes from a to b in the graph structure generated by the spatial data collecting unit 452.

The shortest route calculating unit 454 may calculate the shortest route among the plurality of routes based on the Dijkstra algorithm.

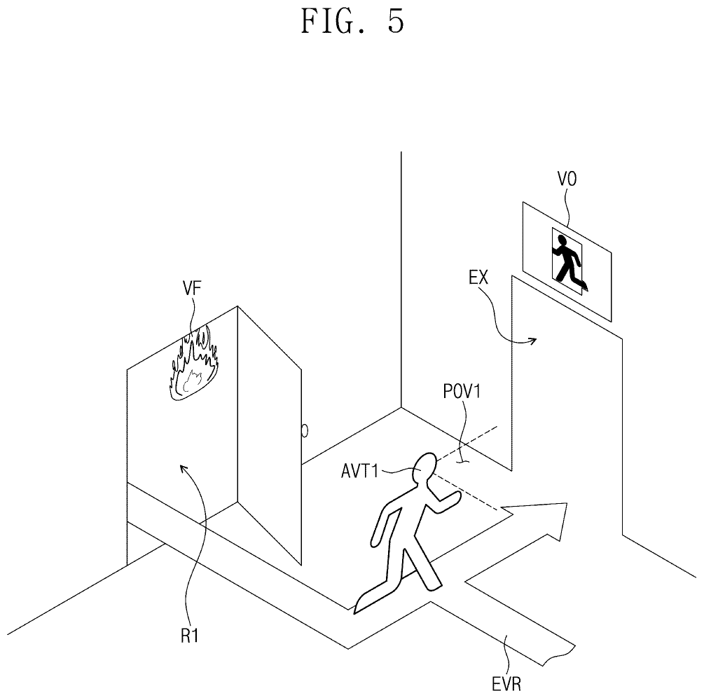

The algorithm generating unit 455 may visualize the shortest route to generate an evacuation route algorithm EVR (see FIG. 5).

The evacuation route calculating unit 450 may provide the generated evacuation route algorithm EVR (see FIG. 5) to the simulation unit 440.

FIG. 5 illustrates a portion of virtual reality provided by an image providing unit according to an embodiment of the inventive concept.

Referring to FIG. 1 to FIG. 5, the image providing unit HMD may receive the virtual reality VR from the server system 400. The image providing unit HMD may provide an operator with the fire evacuation drill scenario through the virtual reality VR.

The virtual reality VR may display an avatar AVT1. The user US may be synchronized to the avatar AVT1 and be able to view the virtual reality VR through a point of view POV1 of the avatar AVT1.

The user US may control the avatar AVT1 through a controller of the image providing unit HMD and interact with the virtual reality VR.

Based on a virtual fire signal received by the data processing unit 410, the simulation unit 440 may generate a virtual fire VF in the virtual reality VR.

Based on the virtual space generated by the virtual space modeling unit 420, the simulation unit 440 may generate an emergency exit EX, a fire zone R1, an emergency light VO, and the like in the virtual reality VR.

If the user US is the operator, the educational drill scenario may include the fire evacuation drill scenario.

Based on the fire evacuation drill scenario generated by the content generating unit 430, the simulation unit 440 may generate a target pop-up or the like such that the avatar AVT1 may perform an action according to a predetermined scenario. FIG. 5 illustrates, as an example, a case in which the user US is the operator, and the educational drill scenario is the fire evacuation drill scenario.

The simulation unit 440 may receive the evacuation route algorithm EVR generated by the evacuation route calculating unit 450, and may generate the virtual reality VR. The evacuation route algorithm EVR may visually display the shortest route from the fire zone R1 to the emergency exit EX in virtual reality VR.

The avatar AVT1 of the user US may perform the fire evacuation drill scenario according to the evacuation route algorithm EVR.

According to the inventive concept, in the event of an actual fire, the operator may easily evacuate according to the content of the fire evacuation drill scenario performed in the virtual reality VR. In the event of the actual fire, the operator may respond quickly. Therefore, it is possible to prevent the operator from being exposed to the risk of the fire.

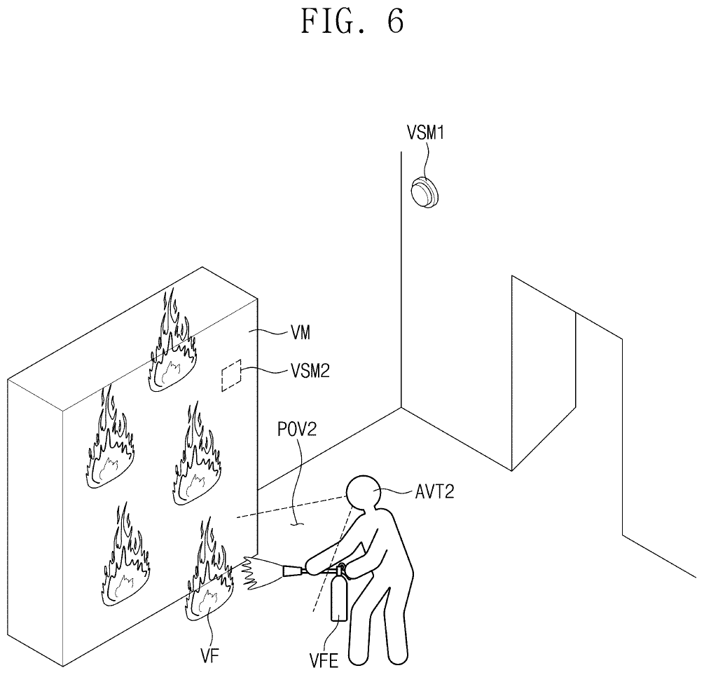

FIG. 6 illustrates a portion of virtual reality provided by an image providing unit according to an embodiment of the inventive concept.

Referring to FIG. 1 to FIG. 3, and FIG. 6, the image providing unit HMD may receive the virtual reality VR from the server system 400. The image providing unit HMD may provide the firefighter with the firefighting drill scenario through the virtual reality VR.

The virtual reality VR may display an avatar AVT2. The user US may be synchronized to the avatar AVT2 and be able to view the virtual reality VR through a point of view POW2 of the avatar AVT2.

The user US may control the avatar AVT2 through a controller of the image providing unit HMD and interact with the virtual reality VR.

Based on a virtual fire signal received by the data processing unit 410, the simulation unit 440 may generate a virtual fire VF in the virtual reality VR.

Based on the virtual space generated by the virtual space modeling unit 420, the simulation unit 440 may generate a virtual facility VM, a virtual first sensor VSM1, a virtual second sensor VSM2, a virtual firefighting facility VFE, and the like in the virtual reality VR.

If the user US is the firefighter, the educational drill scenario may include the firefighting drill scenario.

Based on the firefighting drill scenario generated by the content generating unit 430, the simulation unit 440 may generate a target pop-up or the like such that the avatar AVT2 may perform an action according to a predetermined scenario. FIG. 5 illustrates, as an example, a case in which the user US is the firefighter, and the educational drill scenario is the firefighting drill scenario.

The user US may use the virtual firefighting facility VFE to perform the firefighting drill scenario to extinguish the virtual fire VF.

FIG. 6 illustrates, as an example, that the virtual firefighting facility VFE is a fire extinguisher, the embodiment of the inventive concept is not limited thereto. For example, the firefighting drill scenario may include how to use a fire hydrant, at which time, the virtual firefighting facility VFE may be the fire hydrant.

According to the inventive concept, in the event of an actual fire, the firefighter may easily respond to different types of fires according to the content of the firefighting drill scenario performed in the virtual reality VR. For example, a fire may break out for different reasons in each of a plurality of facilities, and methods for responding thereto may vary. The fire fighter may respond quickly based on an experience in performing the firefighting drill scenario for each virtual facility VM in the virtual reality VR. Therefore, it is possible to take appropriate measures within the golden time and prevent damage to life or property. In addition, a user's on-site response to fires may be improved.

In addition, the user may be the operator. The educational drill scenario may include a scenario for an initial action. The image providing unit HMD may provide the operator with the scenario for an initial action through the virtual reality VR.

According to the above description, in the event of an actual fire, an operator may easily evacuate according to the content of a fire evacuation drill scenario performed in virtual reality. In the event of the actual fire, the operator may respond quickly. Therefore, it is possible to prevent the operator from being exposed to the risk of the fire.

In addition, according to the above description, in the event of an actual fire, a fire fighter may easily respond to different types of fires according to the content of a firefighting drill scenario performed in virtual reality. For example, a fire may break out for different reasons in each of a plurality of facilities, and methods for responding thereto may vary. The fire fighter may respond quickly based on an experience in performing the firefighting drill scenario for each virtual facility in the virtual reality. Therefore, it is possible to take appropriate measures within the golden time and prevent damage to life or property. In addition, a user's on-site response to fires may be improved.

According to the inventive concept, in the event of an actual fire, a nearby operator may quickly perform an initial action according to an experience based on the scenario for an initial action in the virtual reality VR. It is possible to prevent or eliminate an increase in economic damage and casualties due to the spread of fires.

Although the present invention has been described with reference to preferred embodiments of the present invention, it will be understood by those skilled in the art that various modifications and changes in form and details may be made therein without departing from the spirit and scope of the present invention as set forth in the following claims. Accordingly, the technical scope of the present invention is not intended to be limited to the contents set forth in the detailed description of the specification, but is intended to be defined by the appended claims.

What is claimed is:

1. A fire prevention system using virtual reality, the system comprising:
a plurality of first sensors, each of which is configured to detect an outbreak of fire, generate virtual fire information and address information, and perform radio frequency (RF) communication with each other;
a plurality of second sensors respectively attached to a plurality of facilities placed in a building and configured to acquire facility information of each of the plurality of facilities;
a server system configured to generate the virtual reality; and
an image providing unit configured to communicate with the server system, and provide the virtual reality to a user,
wherein the server system includes:
a data processing unit configured to receive the virtual fire information, the address information, the facility information, and information on the user, and generate position information of the plurality of first sensors and state information of the plurality of facilities;
a virtual space modeling unit configured to virtually implement the building and the plurality of facilities to generate a virtual space;
a content generating unit configured to generate an educational drill scenario based on the address information, the facility information, and the information on the user; and
a simulation unit configured to output the educational drill scenario, the position information, and the state information into the virtual space to generate the virtual reality, wherein the image providing unit is configured to provide different virtual reality depending on the user.

2. The fire prevention system of claim 1, wherein the user comprises a firefighter and an operator.

3. The fire prevention system of claim 2, wherein:
if the user is the firefighter, the educational drill scenario comprises a firefighting drill scenario; and
the image providing unit is configured to provide the firefighter with the firefighting drill scenario through the virtual reality.

4. The fire prevention system of claim 2, wherein:
if the user is the operator, the educational drill scenario comprises a fire evacuation drill scenario; and
the image providing unit is configured to provide the operator with the fire evacuation drill scenario through the virtual reality.

5. The fire prevention system of claim 4, wherein the server system further comprises an evacuation route calculating unit configured to generate an evacuation route algorithm; wherein the content generating unit additionally uses the evacuation route algorithm to generate the fire evacuation drill scenario.

6. The fire prevention system of claim 5, wherein the evacuation route calculating unit comprises:
a fire detection data collection unit configured to receive the virtual fire information from the data processing unit;
a space data receiving unit configured to receive the virtual space from the virtual space modeling unit;
an operation unit configured to calculate a plurality of routes by performing a parallel operation based on Compute Unified Device Architecture (CUDA);
a shortest route calculating unit configured to calculate the shortest route among the plurality of routes based on the Dijkstra algorithm; and
an algorithm generating unit configured to generate the evacuation route algorithm by visualizing the shortest route.

7. The fire prevention system of claim 1, wherein the data processing unit further generates a fire index for evaluating a risk of a fire based on an ignition factor, the facility information, the state information, and the position information.

8. The fire prevention system of claim 7, wherein the fire index is provided for each zone, facility, and fuel.

9. The fire prevention system of claim 7, wherein the ignition factor comprises an electrical factor, a mechanical factor, a gas leak, a chemical factor, and a natural factor.

10. The fire prevention system of claim 7, wherein the content generating unit additionally uses the fire index to generate the educational drill scenario.

11. A fire prevention method using a virtual reality system for a building, the method comprising:
installing first sensors in the building, each of which is configured to detect an outbreak of fire, generate virtual fire information and address information, and perform radio frequency (RF) communication with each other;
installing second sensors in the building that are configured to acquire facility information;
generating a virtual reality with a server system for a user for an educational drill scenario based on the facility information of the building and information on the user; and
generating the educational drill scenario customized based on the user information and the facility information for the user.

12. The method of claim 11, wherein the user comprises a firefighter and an operator.

13. The method of claim 12, further comprising if the user is the firefighter, generating the educational drill scenario comprises generating a firefighting drill scenario and providing the firefighter with the firefighting drill scenario through the virtual reality.

14. The method of claim 12, further comprising if the user is the operator, generating the educational drill scenario comprises generating a fire evacuation drill scenario and providing the operator with the fire evacuation drill scenario through the virtual reality.

15. The method of claim 11, further comprising using an evacuation route algorithm to generate the fire evacuation drill scenario.

16. The method of claim 15, further comprising:
receiving the virtual fire information;
receiving the virtual space;
calculating a plurality of routes by performing a parallel operation based on Compute Unified Device Architecture (CUDA);
calculating the shortest route among the plurality of routes based on the Dijkstra algorithm; and
generating the evacuation route algorithm by visualizing the shortest route.
